(19) United States
(12) Patent Application Publication
(10) Pub. No.: US 2026/0368937 A1
(43) Pub. Date: Nov. 19, 2026

(54) ENCODING POINT DATA INDICATING A PLURALITY OF POINTS IN A THREE-DIMENSIONAL SPACE

(71) Applicant: Telefonaktiebolaget LM Ericsson (publ), Stockholm (SE)

(72) Inventors: Niclas SVENSSON, Stockholm (SE); Jacob STRÖM, Stockholm (SE); Rickard SJÖBERG, Stockholm (SE)

(21) Appl. No.: 19/145,597

(22) PCT Filed: Jan. 5, 2024
(86) PCT No.: PCT/EP2024/050198

§ 371 Date: Jul. 3, 2025

Related U.S. Application Data
(60) Provisional application No. 63/437,376, filed on Jan. 6, 2023.

(51) Int. Cl. G06T 9/00

(52) U.S. Cl. CPC G06T 9/001

(57) ABSTRACT

There is provided a method of encoding point data that indicates a plurality of points in a three-dimensional, 3D, environment. The method comprises obtaining the point data and grouping the plurality of points into a plurality of slices which includes a first slice and a second slice, wherein i) the first slice includes a first set of points and a second set of points, 5 and ii) the second slice includes the first set of points and the second set of points. The method further comprises encoding the point data using the plurality of slices. Encoding the point data using the plurality of slices comprises for the first slice, encoding first point data indicating the first set of points, thereby generating a first encoding point; and for the second slice, encoding second point data indicating the second set of points, thereby generating a 0 second encoding point, and the first encoding point and the second encoding point are the same.

### TECHNICAL FIELD

Disclosed are embodiments related to encoding point data indicating a plurality of points in a three-dimensional (3D) space.

### BACKGROUND

Today 3D reconstruction of a space is widely used in various fields. For example, for home renovation, one or more cameras capable of capturing a 360-degree view may be used to capture multiple shots of a kitchen that is to be renovated, and the kitchen may be reconstructed in a 3D virtual space using the captured multiple images. The generated 3D reconstruction of the kitchen can be displayed on a screen, and a user may manipulate the displayed reconstruction in order to help the user to visualize how to renovate the kitchen. In 3D virtual space, there are a plurality of 3D points identifying an object or a structure of the 3D virtual space. In this disclosure, the plurality of 3D points is also referred as a 3D point cloud.

A 3D point cloud is an unstructured set of coordinates of points in a 3D space, and is typically used to capture the geometry and the scale of a scene (i.e., to represent 3D structures from the physical world). In addition to storing the set of point coordinates in a 3D space, a 3D point cloud can store additional information about the 3D points. This additional information is also called attributes. Typical attributes are color information, reflectance, normal vectors, etc.

Even though the embodiments of this disclosure are applicable to point clouds with attributes, for the purpose of simple explanation, the embodiments are explained in the light of geometry compression (i.e., compressing a set of 3D points

$$Ω = {( {X}_{k} , {Y}_{k} , {Z}_{k} )}_{k = 1}^{K} ,$$

where x is the number of points, Xₖ is the X-coordinate of a k-th 3D point, Yₖ is the Y-coordinate of a k-th 3D point, and Zₖ is the Z-coordinate of a k-th 3D point) without attributes.

Typical point clouds range in size from a few kB to several GBs, which puts at stress any application requiring storage and/or transmission of such point clouds. Therefore, efficient point cloud compression solution is needed in all industrial applications relying on such point clouds.

Geometry based Point Cloud Compression (G-PCC) is the current Moving Picture Expert Group (MPEG) standard that targets the use case of static point clouds, as disclosed in Reference 1 cited at the end of this disclosure. It uses octree coding to compress the geometry of 3D points. Before using this method, as shown in FIG. 15A, it is assumed that a coordinate of each 3D point included in the point clouds is quantized into an integer coordinate, and placed within a volume 1502 (e.g., a cube) having the dimension of D×D×D. The volume may be segmented into 8 sub-cubes 1512 having the dimension of D/2× D/2× D/2. If a sub-cube 1512 contains at least one 3D point, then sub-cube 1512 is segmented into 8 smaller sub-cubes 1522 having the dimension of D/4× D/4× D/4. Then if smaller sub-cube 1522 contains at least one 3D point, then smaller sub-cube 1522 may be segmented into 8 micro sub-cubes 1532. This segmentation process can be repeated until a sub-cube of a predetermined size (e.g., D/16× D/16× D/16) containing the 3D point can be identified. On the other hand, if a sub-cube does not contain any 3D points, the segmentation process for this sub-cube branch may end.

The above process generates a tree structure (an octree) (shown in FIG. 15B) where each node can be represented using 8 bits and each bit indicates the occupancy status of one sub-cube. For example, the 8 bits 00010000 may indicate that a fourth sub-cube 1512 contains a 3D point data, and the 8 bits 00000011 may indicate that each of seventh and eighth smaller sub-cubes 1522 contains a 3D point. For lossy compression, an octree is coded as a pre-determined level, thereby generating a sparser reconstruction, and the corresponding sequence of 8-bit words is entropy coded.

G-PCC also contains a module called trisoup, which is explained in Reference 1. The trisoup module was developed to favor surface point clouds, i.e., the point clouds that are dense enough to capture surface structures. Similar to octree G-PCC, this compression module (a.k.a., trisoup coding) uses the octree coding to partition a point cloud into blocks (a.k.a., trisoup nodes). However, when using this module, the octree partitioning typically stops at a higher level in the tree, making the blocks bigger. This level is pre-determined and set by the user/encoder. Instead of setting a fixed depth, the user may set a trisoup node size (nodeSize=2ⁿ, n=2, . . . ), where each node size corresponds to a depth. The purpose of this module is to encode the point cloud at a lower bit rate without losing much accuracy. Compared to octree G-PCC, the reconstructed point cloud will be denser when using trisoup, which typically favors the distortion metrics used in MPEG.

### SUMMARY

In the trisoup coding, points included in each trisoup node are encoded into a group of vertex points that defines a plane on which the points are disposed or which is close to where the points are disposed. More specifically, as shown in FIG. 16A, points 1602 included in a trisoup node 1604 may be encoded into vertex points 1606 and vertex points 1608. As shown in FIG. 16A, vertex points 1606 and 1608 are disposed on boundary surfaces between two adjacent trisoup nodes. Each vertex point on a boundary surface may be determined based on points included in the two adjacent trisoup nodes that are on the opposite sides of the boundary surface. For example, vertex points 1608 disposed on a boundary surface 1610 may be determined based on points 1602 included in trisoup node 1604 and points 1612 included in a trisoup node 1614.

However, certain challenges presently exist in the trisoup coding. In case the two trisoup nodes (e.g., 1604 and 1614) defining the boundary surface (e.g., 1610) on which the vertex points (e.g., 1608) are located belong to the same slice (e.g., slice 1), it is easy to determine the vertex points because all points that should be used for determining the vertex points are included in the same slice, and thus the encoder can access point data indicating the points when processing the slice. On the other hand, in case the two trisoup nodes (e.g., 1614 and 1616) defining the boundary surface (e.g., 1618) on which the vertex points (e.g., 1620) are located belong to different slices (e.g., slices 1 and 2), the encoder may not have all the information (e.g., point data indicating points 1612) it needs to determine the vertex point (e.g., 1620) when processing one of the slices (e.g., Slice 2) because the slices are processed independently from each other.

For example, in determining vertex points 1620, the encoder needs point data indicating points 1612 included in trisoup node 1614 of slice 1 and point data indicating points 1622 included in trisoup node 1616 of slice 2. But in processing slice 1, the encoder does not have access to the point data indicating points 1622 included in trisoup node 1616 of slice 2. Similarly, in process slice 2, the encoder does not have access to the point data indicating points 1612 included in trisoup node 1614 of slice 1. As a result, the vertex points the encoder determines during processing slice 1 may not be same as the vertex points the encoder determines during processing slice 2. For example, in processing slice 1, the encoder may determine that the vertex points of slice 1 include vertex points 1620A while, in processing slice 2, the encoder may determine that the vertex points of slice 2 include vertex points 1620B which are different from vertex points 1620A. This difference will result in discontinuities in the surface in the reconstructed point cloud.

Accordingly, in one aspect, there is provided a method of encoding point data that indicates a plurality of points in a three-dimensional, 3D, environment. The method comprises obtaining the point data; grouping the plurality of points into a plurality of slices which includes a first slice and a second slice, wherein i) the first slice includes a first set of points and a second set of points, and ii) the second slice includes the first set of points and the second set of points; and encoding the point data using the plurality of slices. Encoding the point data using the plurality of slices comprises: for the first slice, encoding first point data indicating the first set of points, thereby generating a first encoding point; and for the second slice, encoding second point data indicating the second set of points, thereby generating a second encoding point, and the first encoding point and the second encoding point are the same.

In another aspect, there is provided an apparatus of encoding point data that indicates a plurality of points in a three-dimensional, 3D, environment. The apparatus is configured to obtain the point data; group the plurality of points into a plurality of slices which includes a first slice and a second slice, wherein i) the first slice includes a first set of points and a second set of points, and ii) the second slice includes the first set of points and the second set of points; and encode the point data using the plurality of slices. Encoding the point data using the plurality of slices comprises: for the first slice, encoding first point data indicating the first set of points, thereby generating a first encoding point; and for the second slice, encoding second point data indicating the second set of points, thereby generating a second encoding point, and the first encoding point and the second encoding point are the same.

In another aspect, there is provided a computer program comprising instructions which when executed by processing circuitry cause the processing circuitry to perform the method of any one of the embodiments described above.

In another aspect, there is provided a carrier containing the computer program of the above described embodiment, wherein the carrier is one of an electronic signal, an optical signal, a radio signal, and a computer readable storage medium.

In another aspect, there is provided an apparatus for encoding point data that indicates a plurality of points in a three-dimensional, 3D, environment. The apparatus is configured to: obtain the point data; group the plurality of points into a plurality of slices which includes a first slice and a second slice, wherein i) the first slice includes a first set of points and a second set of points, and ii) the second slice includes the first set of points and the second set of points; and encode the point data using the plurality of slices. Encoding the point data using the plurality of slices comprises: for the first slice, encoding first point data indicating the first set of points, thereby generating a first encoding point; and for the second slice, encoding second point data indicating the second set of points, thereby generating a second encoding point, and the first encoding point and the second encoding point are the same.

In another aspect, there is provided an apparatus comprising a processing circuitry; and a memory, said memory containing instructions executable by said processing circuitry, whereby the apparatus is operative to perform the method of any one of the embodiments described above.

Some embodiments of this disclosure ensure that there will not be any visible discontinuities in between slices in the reconstructed surfaces by ensuring that the same vertex points for encoding point data are obtained for two adjacent slices at the boundary of the two slices.

The accompanying drawings, which are incorporated herein and form part of the specification, illustrate various embodiments.

### BRIEF DESCRIPTION OF THE DRAWINGS

FIG. 1 shows an exemplary scenario where embodiments of this disclosure can be applied.

FIG. 2A shows an apparatus according to some embodiments.

FIG. 2B shows an example of a virtual reality scene.

FIG. 3 shows a process according to some embodiments.

FIG. 4A shows a bounding box surrounding a 3D point cloud.

FIGS. 4B, 5A, and 5B show a plurality of slices of a bounding box.

FIG. 6 shows a process according to some embodiments.

FIGS. 7A and 7B show a method of partitioning according to some embodiments.

FIG. 8A shows a method of encoding point data according to some embodiments.

FIG. 8B shows a method of decoding point data according to some embodiments.

FIGS. 9A-9F show a padding process according to some embodiments.

FIG. 10A shows a padding process according to some embodiments.

FIG. 10B shows a result of a padding process according to some embodiments.

FIG. 11 shows a process of determining vertex points according to some embodiments.

FIG. 12A shows an original boundary of a slice.

FIG. 12B illustrates how extra vertices can be added to the bitstream, apart from the duplicate vertices on the slice boundary.

FIG. 13 shows a process according to some embodiments.

FIG. 14 shows an apparatus according to some embodiments.

FIG. 15A illustrates an octree coding method.

FIG. 15B illustrates an octree coding method.

FIG. 16A shows a method of calculating vertex points.

FIG. 16B shows a method of calculating vertex points.

### DETAILED DESCRIPTION

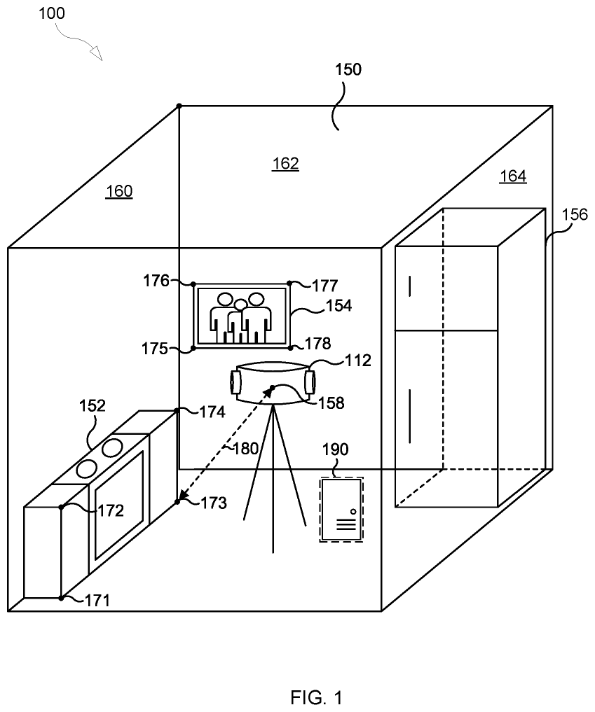

FIG. 1 shows an exemplary scenario 100 where embodiments of this disclosure are implemented. In scenario 100, a capturing device 112 is used to capture a view of a kitchen 150. In kitchen 150, an oven 152, a picture frame 154, and a refrigerator 156 are placed. As shown in FIG. 1, oven 152 is placed against a first wall 160, picture frame 154 is placed against a second wall 162, and refrigerator 156 is placed against second wall 162 and a third wall 164.

Capturing device 112 includes a camera and a Light Detection and Ranging (LiDAR) sensor. The camera is configured to capture a view of kitchen 150. One example of the camera is a 360-degree camera-a camera that is capable of capturing a 360-degree view of a real-world environment.

The LiDAR sensor is configured to collect depth values of various real-world points (e.g., points 171-178) of kitchen 150. Here, a depth value of a particular real-world point indicates a distance between a view point 158 of capturing device 112 and the particular real-world point. For example, a depth value of a real-world point 173 indicates a distance 180 between point 173 and view point 158. One example of view point 158 is a center point of the camera.

Once the view of kitchen 150 is captured by the camera and depth values of the real-world points included in the view of kitchen 150 are measured by the LiDAR sensor, capturing device 112 may transmit the captured and/or measured data to a computing device 190 which is connected to capturing device 112 (wirelessly or via a wired connection). After receiving the data, computing device 190 may combine the data collected by the camera and the data collected by the LiDAR sensor, thereby generating 3D point data indicating a plurality of a three-dimensional (3D) points.

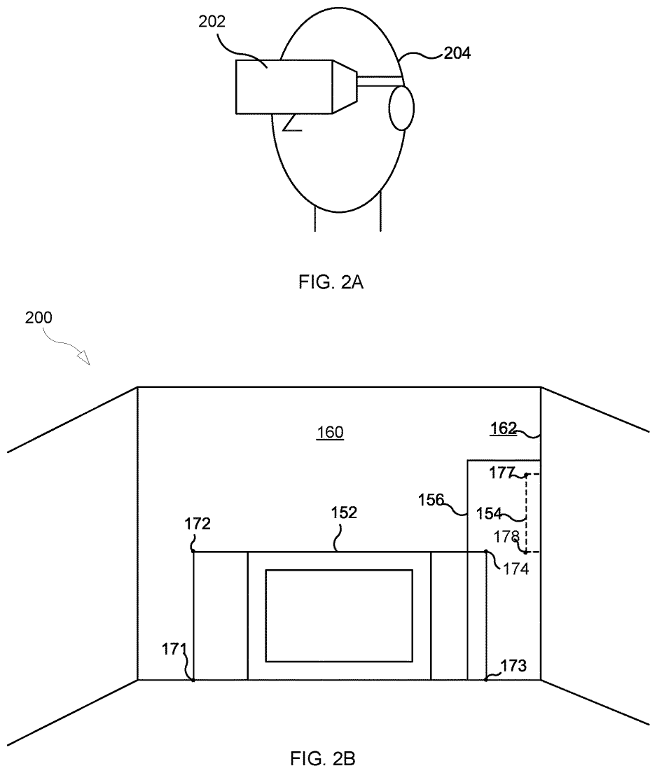

In some embodiments, the 3D point data indicating the 3D points may be used to reconstruct the real-world environment captured by capturing device 112. For example, the 3D point data indicating the 3D points may be used to generate an extended-reality (XR) (including a virtual-reality, a mixed-reality, or an augmented-reality) scene using an XR display 202 shown in FIG. 2A. View 200 shown in FIG. 2B is an example of the view user 204 sees via XR display 202. The 3D point data of each 3D point may include a 3D coordinate of the 3D point and/or attributes such as color/luminance values of the 3D point.

The 3D point data indicating the plurality of 3D points generated by computing device 190 may be stored in a storage (e.g., included in computing device 190). However, typical size of the 3D point data ranges from 1 GB to several GBs, and thus storing the 3D point data would require a substantial amount of storage space.

Additionally, in some scenarios, there is a need to send the point data of the 3D points from one entity to another entity. For example, assume that an owner of a house wants to renovate kitchen 150 but a kitchen designer is located far from the house. In such case, once a view of kitchen 150 is captured and the point data identifying the 3D points of kitchen 150 is generated by computing device 190, the point data may be sent from computing device 190 to XR display device 202 such that the kitchen designer can see the reconstructed 3D view of kitchen 150. However, due to the large size of point data, transmitting the 3D point data would consume a substantial amount of data bandwidth.

Therefore, there is a need for efficiently compressing and decompressing the 3D point data indicating the plurality of 3D points.

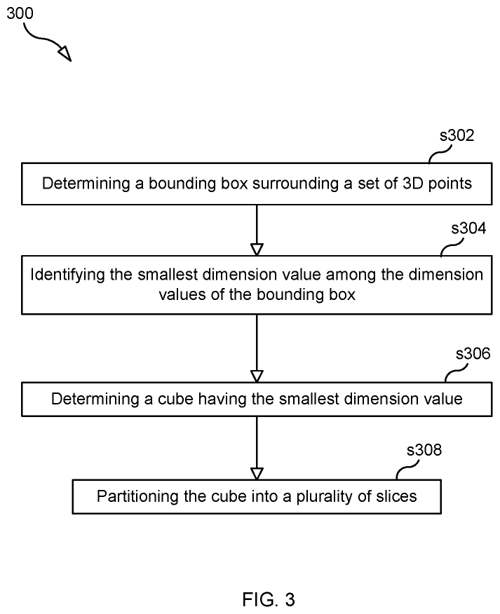

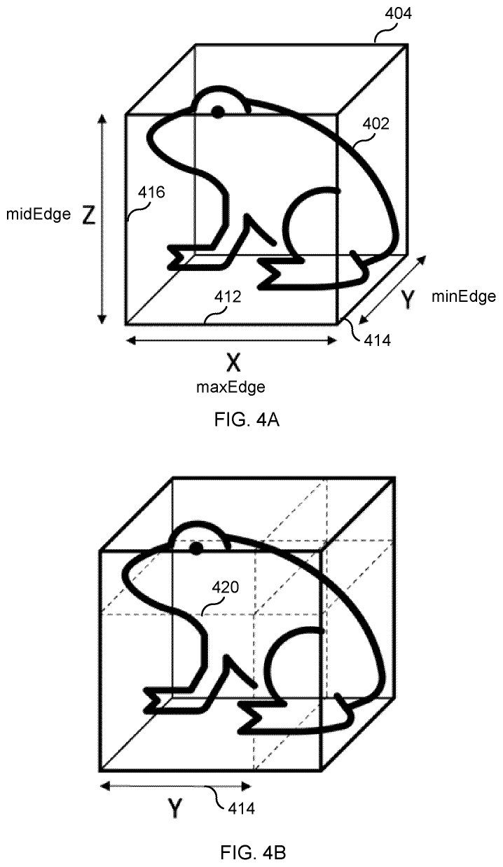

FIG. 3 shows a process 300 for compressing (i.e., encoding) 3D point data indicating a set of 3D points (a.k.a., a “3D point cloud” or “point cloud”) in the MPEG Geometry based Point Cloud Compression (G-PCC) Common Test Conditions (CTC). Process 300 may begin with step s302. Step s302 comprises determining a bounding box that surrounds the set of 3D points. For example, in FIG. 4A, the set of 3D points forms the shape of a frog 402, and via step s302, a bounding box 404 surrounding frog 402 is obtained. As shown in FIG. 4A, bounding box 404 has a first dimension value 412 (e.g., the width in X direction), a second dimension value 414 (e.g., the depth in Y direction), and a third dimension value 416 (e.g., the height in Z direction).

After determining bounding box 404, process 300 may proceed to step s304. Step s304 comprises identifying the smallest dimension value among first, second, and third dimension values 412, 414, and 416. In the example shown in FIG. 4A, second dimension value 414 is the smallest.

After identifying the smallest dimension value, process 300 may proceed to step s306 which comprises determining a cube having the smallest dimension value. For example, since second dimension value 414 is the smallest, in step s306, as shown in FIG. 4B, a cube 420 (the bottom left box among the four boxes bounded by dotted lines) having second dimension value 414 is obtained.

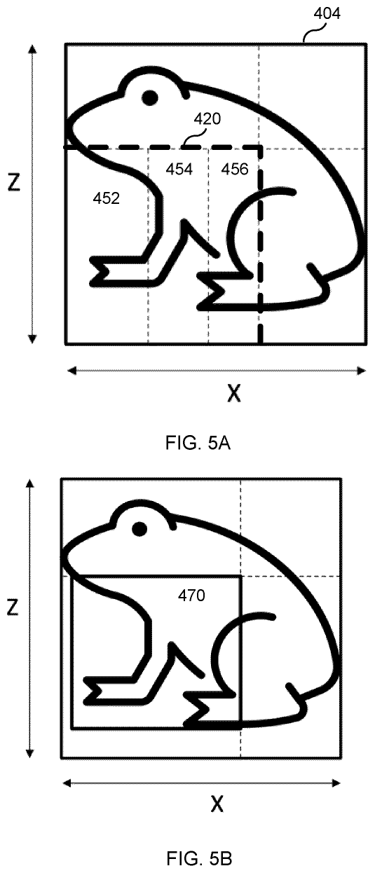

After determining cube 420, process 300 may proceed to step s308. Step s308 comprises partitioning cube 420 into a plurality of slices. For example, FIG. 5A shows the X-Z plane view of bounding box 404, and in FIG. 5A, cube 420 is partitioned into a plurality of slices 452, 454, and 456. A point cloud Ω partitioned into M slices can therefore be described as

$$Ω = {⋃}_{i = 0}^{M - 1} {Ω}_{i} ,$$

where Ωᵢ represents the set of points in a specific slice. A point cloud Ω partitioned into M slices can therefore be described as

$$Ω = {⋃}_{i = 0}^{M - 1} {Ω}_{i} ,$$

where Ωᵢ represents the set of points in a specific slice.

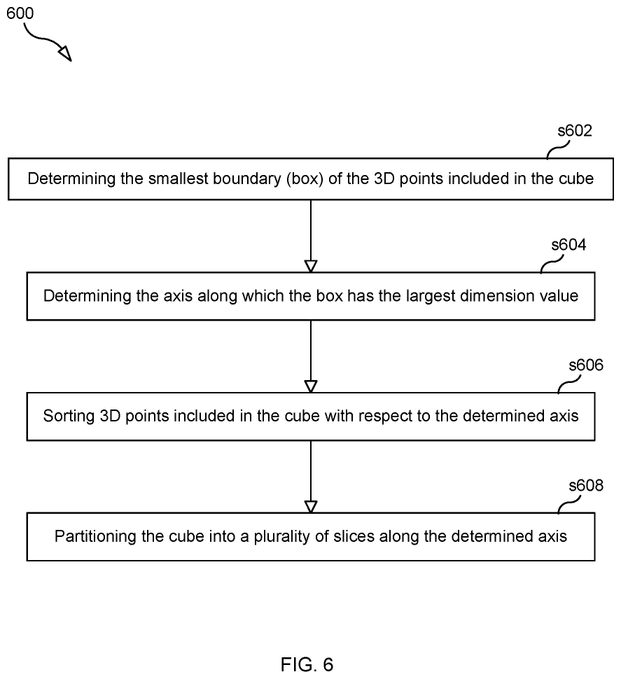

FIG. 6 shows a process 600 for partitioning cube 420 into a plurality of slices 452, 454, and 456 according to some embodiments. Process 600 may begin with step s602. Step s602 comprises determining the smallest boundary of the 3D points included in cube 420. For example, as shown in FIG. 5B, the smallest boundary of the 3D points (corresponding to the shape of frog 402) included in cube 420 is a box 470 (a rectangle in the x-z plane view) that is smaller than cube 420.

Then, in step s604, the axis along which box 420 has the largest dimension value is determined. For example, in FIG. 5B, the dimension value of box 470 along the x-axis (i.e., the width) is greater than the dimension value of box 470 along the z-axis (i.e., the height). Thus, in step s604, the x-axis is identified. The axis determined in step s604 corresponds a direction of partitioning cube 420 (i.e., thereby partitioning cube 420 into the plurality of slices 452, 454, and 456, which are arranged along the x-axis).

After determining the direction of partitioning cube 402 (a.k.a., slicing direction or split direction), step s606 may be performed. Step s606 comprises sorting the 3D points included in cube 402 along the x-axis. More specifically, the 3D points may be sorted such that they are arranged in the order of the 3D point having the smallest x coordinate to the 3D point having the largest x coordinate. For example, for simple explanation purpose, let's assume that there are three 3D points in cube 402—p1 (x1,y1,z1), p2(x2,y2,z2), and p3(x3,y3,x3), and x2>x1> x3. Then, via step s606, the 3D points will be sorted in the sequence of p3, p1, and p2.

Referring back to FIG. 6, after sorting the 3D points in step s606, step s608 may be performed. Step s608 comprises partitioning cube 420 into a plurality of slices along the axis determined in step s604 (i.e., the x-axis) such that a number of 3D points included in each of the slices is less than or equal to a threshold value. Here, the threshold value indicates the maximum number of 3D points that are allowed to be included in each slice. The threshold value may be a predefined value or may be set by a user.

To make sure that the slices have sides that are multiples of nodeSize (making it easier to partition each slice into an octree where the full range of voxels are occupied), the side of the slices may be rounded up to the closest integer divisible by nodeSize This rounded number is called the sliceSize and determines the longest possible bounding box side of a slice. To ensure that a certain threshold of points (Nₜₕ, set to 1100000 in G-PCC CTC) are not exceeded within each slice, these uniform cubic slices may further be split. When an already existing slice is further separated into smaller slice, along a particular direction, this is referred splitting. However, the result of the splitting will not be cubic slices. Instead, they are split along the longest axis of the slice (the maxEdge of the slice).

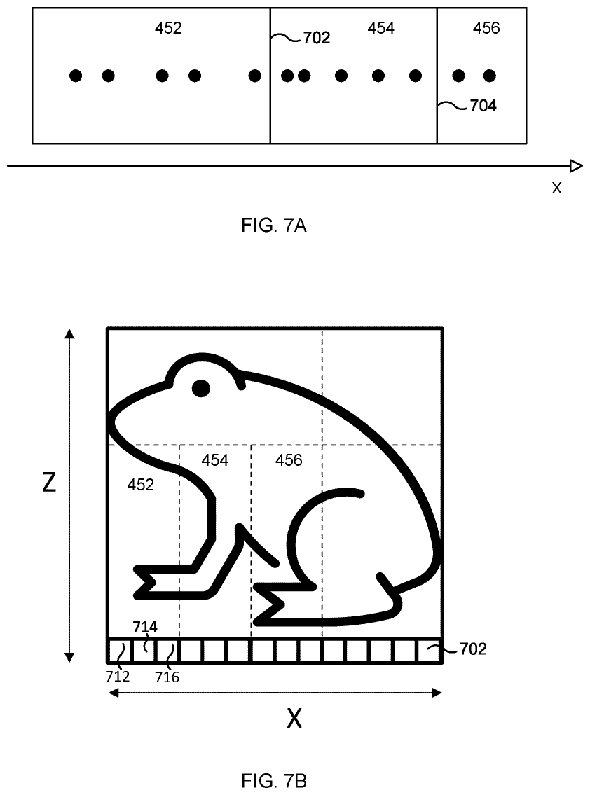

To be clear, maxEdge is not the size of the longest axis, instead maxEdge is the dimension of the longest axis. If the point cloud is largest in the x-direction, maxEdge will be 0. If the point cloud is instead largest in the y-dimension, maxEdge will be 1, and if the z-direction is the largest, maxEdge will be 2. Hence maxEdge will always be 0, 1 or 2. The slices are split where there is a node boundary as well to ensure that the thickness of the slices is a multiple of nodeSize (see FIG. 7B). Slices are encoded independently of each other.

FIG. 7A shows a graphical representation of the sorted 3D points obtained in step s606. After obtaining the list of the sorted 3D points, first slice 452 that contains up to the maximum allowed number of 3D points is determined. For example, in case the threshold value is 5, a boundary 702 of first slice 452 is determined such that first slice 452 contains only up to five 3D points. Similarly, a boundary 704 of second slice 454 is determined such that second slice 454 contains only up five 3D points.

In case the dimension of each of first, second, and third slices 452, 454, and 456 is an integer multiple of the size of the trisoup node, as shown in FIG. 7B, each of the slices is encoded using one or more trisoup nodes. For example, FIG. 7B shows that three trisoup nodes 712, 714, and 716 are included in first slice 452, and the 3D points included in each of trisoup nodes 702, 704, and 706 may be grouped and encoded together.

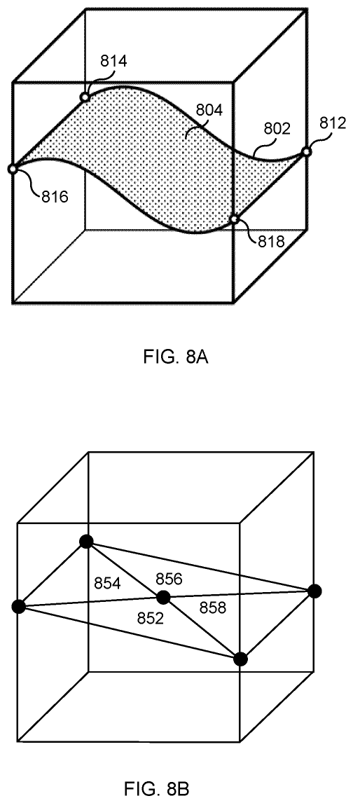

FIG. 8A illustrates how 3D points included in a trisoup node can be encoded together. As shown in FIG. 8A, first, a point surface 802 on which 3D points 804 (the very small dots included in surface 802) are located is determined. Point surface 802 may be a curved surface or a flat surface (depending on the distribution of the 3D points). Once point surface 802 is determined, cross points (a.k.a., “vertex points”) 812, 814, 816, and 818 at which point surface 802 crosses the boundary of the trisoup node are determined. Additionally, a center point 830 of point surface 802 may be determined. The vertex points may be determined according to the method described below.

Based on the number of nodes (numNodes) in a slice, the number of points (numPoints) in the same slice and the node size (nodeSize), a distance (distanceSearchEncoder) is calculated according to:

$$distanceSearchEncoder = max ( 1 , min ( \sqrt{\frac{numNodes}{numPoints}} * nodeSize , 8 ) )$$

This distance represents the largest perpendicular distance from an edge that a point must be within in order to count as intersecting with that edge. If a point is within that distance from the edge, it will be added to the set of points that intersects with that edge. However, there can only be one vertex point per edge, so the position of the vertex point may be calculated as the average position of the points intersecting the edge.

After determining vertex points 812, 814, 816, and 818 and center point 830 of point surface 802, data corresponding to vertex points 812, 814, 816, and 820, and center point 830 is generated and transmitted to a decoding entity. Upon receiving the data, the decoding entity may be configured to reconstruct point surface 802 using the data, and reconstruct the 3D points of the trisoup node using the reconstructed surface.

One way of reconstructing point surface 802 at the decoding entity is illustrated in FIG. 8B. As shown in FIG. 8B, point surface 802 may be reconstructed by finding a plurality of triangle areas 852, 854, 856, and 858 using the vertex points and the center point. For example, triangle area 852 is formed by vertex points 816 and 818, and center point 830, triangle area 854 is formed by vertex points 814 and 816, and center point 830, triangle area 856 is formed by cross points 812 and 814, and center point 830, and triangle area 858 is formed by vertex points 812 and 818, and center point 830. When decoding the point cloud, surfaces of each block is reconstructed by populating all positions for points (called voxels) that intersect the modelled triangles.

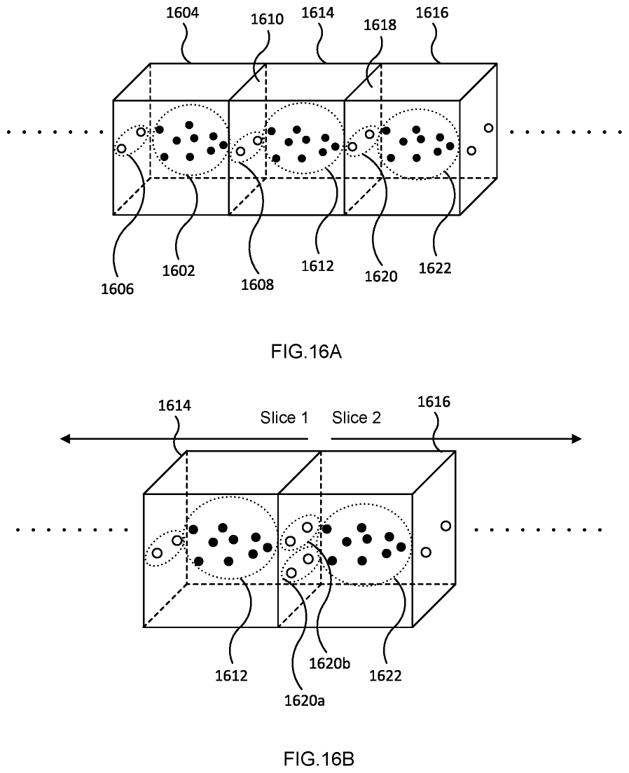

As explained with respect to FIGS. 16A and 16B, in order to calculate vertex points 1620a for encoding point data indicating points 1612 included in a trisoup node 1614, both of point data indicating points 1612 and point data indicating points 1622 are needed. However, in case trisoup node 1614 including points 1612 and trisoup node 1616 including points $22 do not belong to the same slice, all point data needed for calculating correct vertex points 1620a may not be available. For example, in calculating vertex points 1620a for encoding point data indicating points 1612 for slice 1, point data indicating points 1622 may not be available. Similarly, in calculating vertex points 1620b for encoding point data indicating points 1622 for slice 2, point data indicating points 1612 may not be available. Such unavailability of certain point data may result in inconsistent vertex points (e.g., 1620a and 1620b) at the boundary of the slices.

Thus, according to some embodiments of this disclosure, the point cloud is divided into the slices such that adjacent slices overlap with each other, thereby sharing certain points. Configuring the adjacent slices to overlap with each other would ensure that each slice has all point data needed for calculating the vertex points at the boundary surface between two adjacent slices. For example, according to some embodiments, the slice 1 shown in FIG. 16B may be set to include point data indicating points 1622, and the slice 2 shown in FIG. 16B may be set to include point data indicating points 1612. Then, in encoding the slice 1, the vertex points 1620a can be determined based on the point data indicating points 1612 and the point data indicating points 1622. Similarly, in encoding the slice 2, the vertex points 1620b can be determined based on the point data indicating points 1612 and the point data indicating points 1622. Since the same point data indicating the same points (i.e., 1612 and 1622) is used for determining the vertex points when encoding the slice 1 and when encoding the slice 2, the determined vertex points for the slice 1 would be same as the determined vertex points for the slice 2, and thus the above-described inconsistent problem can be solved.

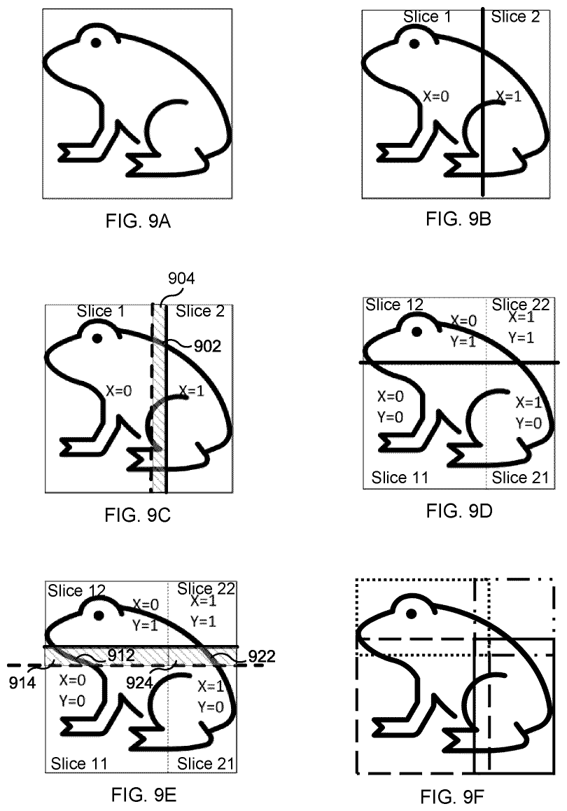

In order to configure adjacent slices to overlap partially, according to some embodiments, during the partitioning of the point cloud into the slices, it is checked as to whether a current point belonging to a current slice is within an expansion area (a.k.a., a padding area) of an adjacent slice that is adjacent to the current slice. If so, the point is also added to the adjacent slice. FIGS. 9A-9E illustrate this concept.

FIG. 9A shows an unpartitioned point cloud, FIG. 9B shows a result of partitioning the point cloud in the x-direction without applying the concept described above, and FIG. 9C shows a result of partitioning the point cloud in the x-direction with applying the concept described above. In FIG. 9B, there is no overlapping area between slices 1 and 2. On the contrary, in FIG. 9C, since points 902 belonging to the slice 1 is within an expansion area 904 of the slice 2, points 902 are added to the slice 2 (thereby increasing the size of the slice 2 such that the slice 2 now overlaps the slice 1). Note that the size of the slice 1 can be increased in the similar manner such that the slice 1 overlaps the slice 2.

Similarly, FIG. 9D shows a result of partitioning the point cloud in the y-direction without applying the concept described above, and FIG. 9E shows a result of partitioning the point cloud in the y-direction with applying the concept described above. In FIG. 9D, there is no overlapping area between slices 11 and 12, and no overlapping area between slices 21 and 22. On the contrary, in FIG. 9E, since points 912 belonging to the slice 11 is within an expansion area 914 of the slice 12, points 912 are added to the slice 12. Similarly, since points 922 belonging to the slice 21 is within an expansion area 924 of the slice 22, points 922 are added to the slice 22. FIG. 9E shows the result of the padding (i.e., adding to a slice points of an adjacent slice).

According to some embodiments, the size of the expansion area may be set by a user or may be set to be a preconfigured value. One example of the size of the expansion area is a size of a trisoup node (i.e., nodeSize). For simple explanation purpose, in the rest of this disclosure, the nodeSize and the size of the expansion area are used interchangeably.

There are different ways of adding points of a first slice, which are within an expansion area of a second slice adjacent to the first slice, to the second slice. One way is using the condition below.

(y*sliceSize−nodeSize)≤Ω_{x,y}[i][midEdge]<((y+1)*sliceSize+nodeSize)

Here, y corresponds to a slice index value indicating a slice, sliceSize is a value indicating the size of the slice, nodeSize is a value indicating the size of a trisoup node, and Ω_{x,y}[i] [midEdge] is a value indicating a coordinate (in the midEdge axis) of a point Ω_{x,y}[i] having an index i in the point cloud. For example, Ω_{x,y}[0][0] may indicate the x-coordinate value of the point having the index value of 0, Ω_{x,y}[0][1] may indicate the y-coordinate value of the point having the index value of 0, and Ω_{x,y}[0][2] may indicate the z-coordinate value of the point having the index value of 0.

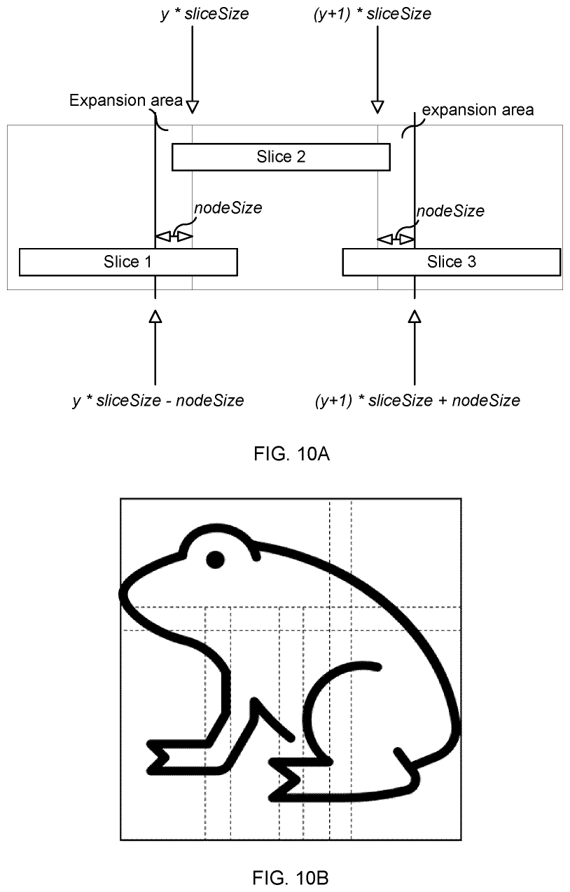

If the above condition is true, then the point may be added to the slice. As shown in FIG. 10A, adding points using the above condition results in increasing the size of a slice. For example, in FIG. 10A, the original boundaries of slice 2 correspond to y*sliceSize and (y+1)*sliceSize, and the updated boundaries of slice 2 correspond to y*sliceSize−nodeSize and (y+1)*sliceSize+nodeSize. By updating the boundaries, additional points that can be used for calculating correct vertex points on a slice boundary can be included in slice 2.

As explained above, the width of the expansion area (a.k.a., the padding area) can be of any value. However, it could be satisfactory just to set the width of the expansion area to be the width of a trisoup node (i.e., setting the width of the expansion area to be the “nodeSize”) to get improved encoding results because the current reference software will only use points within one nodeSize distance from the edge to determine the position of the vertices. Even though the value of the distanceSearchEncoder, at least in theory, could be larger than the value of nodeSize, in practice, this happens so rarely that it can be ignored.

When splitting slices that contain too many points, the current software sorts the points within a slice based on the coordinate of the maxEdge axis of the slice. It then proceeds to loop over the points remembering the indices of the points before which it is possible to split the slice in order to align the boundaries of the nodes and the slices. This is the first point in (potentially) a sequence of points with the same maxEdge coordinate, where Ω_{x,y}[i][maxEdge] is divisible by nodeSize. Instead of splitting the slice at this index, the splitting may be performed at the previous index where this condition was true. This will also be the starting index of the next slice.

In some embodiments, the slice can be padded with an arbitrary number less than nodeSize. For example, if the padding is set to X (X≤nodeSize), then instead of remembering all points where Ω_{x,y}[i][maxEdge] is divisible by nodeSize, all first points in the sorted sequence, where Ω_{x,y}[i][maxEdge]+X is divisible by nodeSize may be remembered.

The final partitioning of the point cloud with overlapping slices is shown in FIG. 10B. This overlapping of the slices has some further impact on the reconstructed point cloud. For instance, when including more points in a slice both numNodes and numPoints will be affected. In the best possible scenario, the padding nodes will have similar characteristics as the original nodes, hence, not changing the value of the distanceSearchEncoder noticeably. However, this is not guaranteed and therefore, in some embodiments, the original values of numNodes, numPoints, and nodeSize (based on non-padded slices) are used when calculating the value of the distanceSearchEncoder.

In some rare cases, two adjacent slices could encapsulate two different parts of the point cloud having very different characteristics, thereby resulting in the two adjacent slices to have different distanceSearchEncoder values.

For example, assume that slice 1 has the distanceSearchEncoder value of 1 and slice 1 has the distanceSearchEncoder value of 2. In this exemplary scenario, the problem is that the slice 1 would only use one layer of padding (i.e., using a padding area having width 1) from the slice 2 to calculate the vertex points on a boundary surface between the slices 1 and 2 while the slice 2 would use two layers of padding (i.e., using a padding area having width 2) from the slice 1 to calculate the vertex points on a boundary surface between the slices 1 and 2. Since each of the slices 1 and 2 would use a different number of padding layers, the vertex points each of the slices 1 and 2 calculates may be different.

To avoid the above described problem, there is provided the following method of calculating the value of the distanceSearchEncoder for determining vertex points on the slice boundary.

First, the value of the distanceSearchEncoder is calculated for each of the two different adjacent slices, and if they are not equal, the larger one may be selected and used for determining the vertex points lying on the boundary plane between slices. For determining the vertex points that do not lie on the boundary plane between slices, the value of the distanceSearchEncoder that is unique to each slice is used. This will guarantee that the vertex positions on slice boundaries are the same in both slices.

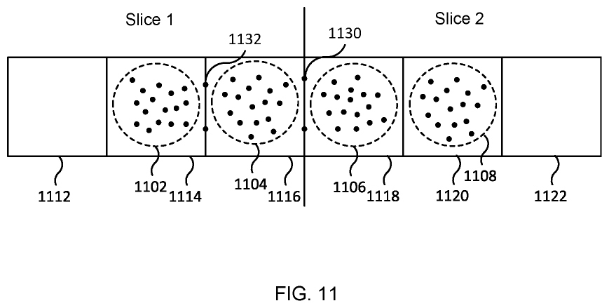

For example, in FIG. 11, slice 1 including trisoup nodes 1112, 1114, and 1116 has the distanceSearchEncoder of value of 1 while slice 2 including trisoup nodes 1118, 1120, and 1122 has the distanceSearchEncoder of value of 2. Since the slices 1 and 2 have different values of the distanceSearchEncoder, the larger one (here, the distanceSearchEncoder of value of 2) is used for calculating vertex points 1130 (since vertex points 1130 lie on the boundary plane between slices 1 and 2) but the distanceSearchEncoder of value of 1 is used for calculating vertex points 1132 (since vertex points 1132 lie on the boundary plane that is not between two slices). More specifically, in encoding point data indicating points included in slice 1, vertex points 1130 are determined based on points 1102 included in node 1114, points 1104 included in node 1116, points 1106 included in node 1118, and points 1108 included in node 1120 (corresponding to the distanceSearchEncoder of value of 2). On the contrary, in encoding point data indicating points included in slice 1, vertex points 1132 are determined based on points 1102 of node 1114 and points 1104 of node 1116 (corresponding to the distanceSearchEncoder of value of 1).

This method may be preferably used when each slice is padded with a padding layer having one nodeSize. This is because the encoder cannot know, before partitioning the point cloud, what the distanceSearchEncoder value will be. Hence, the encoder must use a padding layer having one entire nodeSize in order to ensure that the distanceSearchEncoder value is not bigger than a user set padding value of X. However, this method can also be used in case a padding layer having a user configured padding width X which is different from the nodeSize.

Note that, according to some embodiments, in calculating the value of the distanceSearchEncoder, the original values of numNodes, numPoints, and nodeSize may be used (i.e., the values of numNodes, numPoints, and nodeSize of a slice before padding). This is because these values will not change no matter how many layers of padding are added.

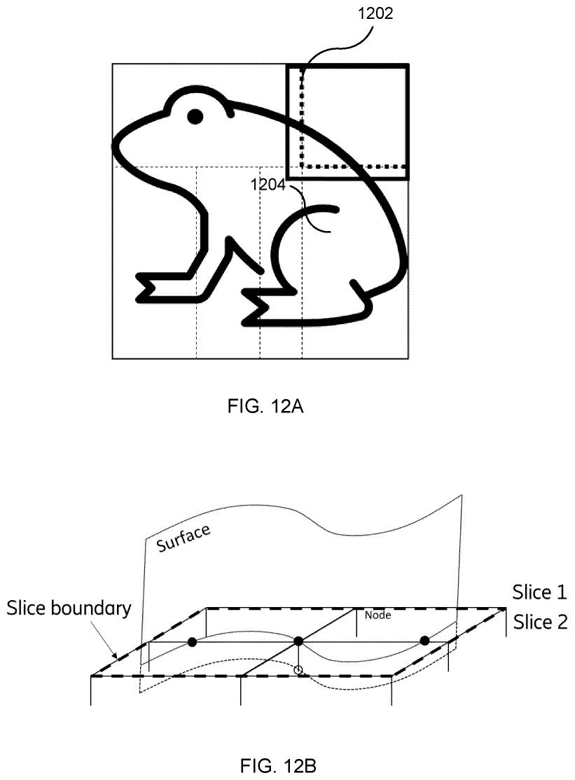

The data structure representing a slice may include a member variable which indicates the bounding box (1202 shown in FIG. 12A as compared to 1204 which indicates a boundary of a slice with a padding layer) of a volume that the slice should represent (which means excluding the padding used for determining correct vertex points on slice boundaries). When determining vertex points, all vertex points that are outside of the bounding box may be removed and hence not included in the bitstream. This reduces the size of the bitstream without affecting the distortion metric score. Duplicate vertices that are not situated on slice boundaries (shown in FIG. 12B) may also be removed. In a summary, in encoding a slice, the method according to some embodiments may keep the original slice information (i.e., the information about a slice before padding), and use the original slice information to remove vertex points outside of the original slice bounding box, which are generated by the padding, to improve encoding efficiency.

Even though the embodiments described above are explained with respect to a scenario where each vertex point on a boundary surface is determined based on points included in two adjacent trisoup nodes that are on the opposite sides of the boundary surface, the embodiments are equally applicable to the scenario where a vertex point on a boundary surface is determined based on points included in three or four adjacent trisoup nodes near the boundary surface. For example, a vertex point may be located on an edge formed by four trisoup nodes. In such case, the vertex point may be determined based on points included in the four trisoup nodes.

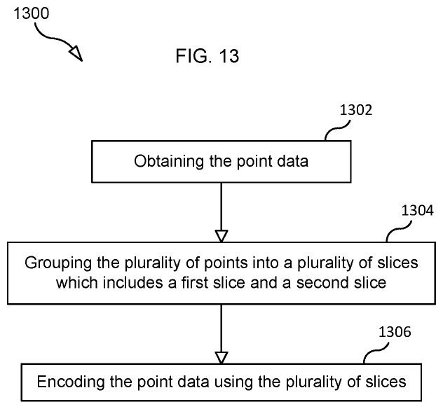

FIG. 13 shows a process 1300 of encoding point data that indicates a plurality of points in a three-dimensional, 3D, environment, according to some embodiments. Process 1300 may begin with step s1302. Step s1302 comprises obtaining the point data. Step s1304 comprises grouping the plurality of points into a plurality of slices which includes a first slice and a second slice, wherein i) the first slice includes a first set of points and a second set of points, and ii) the second slice includes the first set of points and the second set of points. Step s1306 comprises encoding the point data using the plurality of slices. Encoding the point data using the plurality of slices comprises: for the first slice, encoding first point data indicating the first set of points, thereby generating a first encoding point; and for the second slice, encoding second point data indicating the second set of points, thereby generating a second encoding point. The first encoding point and the second encoding point are the same.

In some embodiments, the first slice and the second slice partially overlap.

In some embodiments, process 1300 comprises obtaining an initial slice length value indicating an initial length of a slice along a first axis; and obtaining an expansion length value indicating a length of an expansion area of a slice along the first axis, wherein a length of each of the plurality of slices along the first axis is either a sum of the initial length and the length of the expansion area or a sum of the initial length and twice of the length of the expansion area, and an overlapped area of the first slice and the second slice is twice of the length of the expansion area.

In some embodiments, the first slice includes a first initial slice area containing the first set of points and a first expansion area containing the second set of points, the second slice includes a second initial slice area containing the second set of points and a second expansion area containing the first set of points, and the first encoding point and the second encoding point are on a boundary surface between the first initial slice area and the first expansion area and between the second initial slice area and the second expansion area.

In some embodiments, the first encoding point is generated for the first slice based on the first set of points and the second set of points, and the second encoding point is generated for the second slice based on the first set of points and the second set of points.

In some embodiments, process 1300 comprises for the first slice, determining a first surface on which the first set of points included in the first initial slice area and the second set of points included in the first expansion area are located, and for the second slice, determining a second surface on which the second set of points included in the second initial slice area and the first set of points included in the second expansion area are located. The first encoding point is an intersection point that the determined first surface intersects the boundary surface, the second encoding point is an intersection point that the determined second surface intersects the boundary surface, and the first surface and the second surface are the same.

In some embodiments, grouping the plurality of points into the plurality of slices comprises: determining dimension values each indicating a dimension of a geometry that surrounds the plurality of points, wherein each point is defined by coordinate values each of which indicates a coordinate corresponding to a dimension of the geometry; identifying the longest dimension from among the dimensions of the geometry; dividing each point's coordinate value corresponding to the longest dimension by the initial slice length value; and determining which of the plurality of slices each of the plurality points belongs to based on a result of the division of each point's coordinate value corresponding to the longest dimension by the initial slice length value.

In some embodiments, grouping the plurality of points into the plurality of slices comprises: identifying the second longest dimension from among the dimensions of the geometry; dividing each point's coordinate value corresponding to the second longest dimension by the initial slice length value; and determining which of the plurality of slices each of the plurality points belongs to based on a result of the division of each point's coordinate value corresponding to the second longest dimension by the initial slice length value.

In some embodiments, the plurality of points includes a first point, grouping the plurality of points into the plurality of slices comprises: determining that the first point is included in the first slice, determining whether the first point is within a first adjacent area of the first slice, where the first adjacent area of the first slice is adjacent to the second slice, and as a result of determining that the first point is within the first adjacent area of the first slice, including the first point in the second slice.

In some embodiments, the plurality of points includes a first point within the second slice, the first slice and the second slice area are arranged along a first axis, and grouping the plurality of points into the plurality of slices comprises: determining whether (a−(b×c))≤d, where a is a coordinate of the first point along the first axis, b is the initial slice length value, c is an index of the second slice along the first axis, and d is the expansion length value; and as a result of determining that (a−(b×c))≤d, including the first point in the first slice.

In some embodiments, the plurality of points includes a first point, the first slice and the second slice area are arranged along a first axis, and grouping the plurality of points into the plurality of slices comprises: including the first point in the first slice if the following condition is satisfied: (b×c−d)≤a≤(b×(c+1)−d), where a is a coordinate of the first point along the first axis, b is the initial slice length value, c is an index of the second slice along the first axis, d is the expansion length value.

In some embodiments, process 1300 comprises transmitting towards a decoding entity encoded point data, wherein the encoded point data includes first encoded point data for the first slice and second encoded point data for the second slice, the first encoded point data for the first slice indicates the first encoding point, and the second encoded point data for the second slice indicates neither the first encoding point nor the second encoding point.

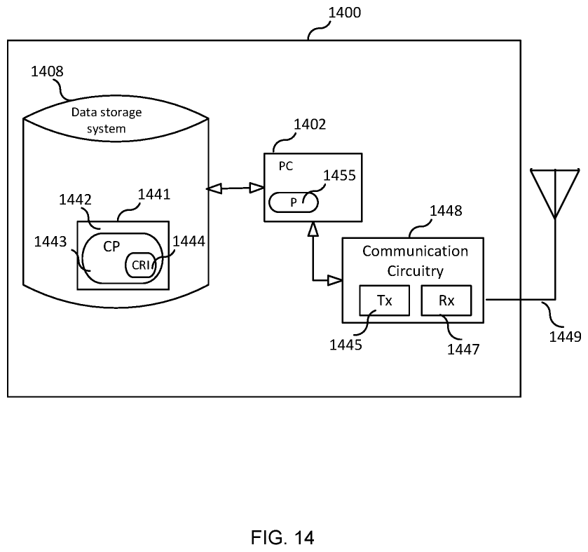

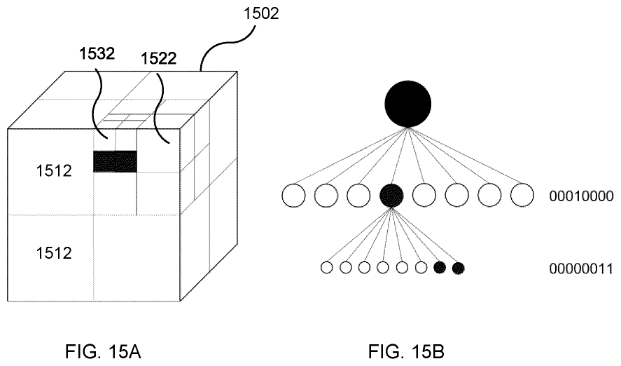

FIG. 14 is a block diagram of an apparatus 1400 for implementing an encoder, a decoder, or a component included in the encoder or the decoder, according to some embodiments. When apparatus 1400 implements a decoder, apparatus 1400 may be referred to as a “decoding apparatus 1400,” and when apparatus 1400 implements an encoder, apparatus 1400 may be referred to as an “encoding apparatus 1400.” As shown in FIG. 14, apparatus 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus); at least one network interface 1448 comprising a transmitter (Tx) 1445 and a receiver (Rx) 1447 for enabling apparatus 1400 to transmit data to and receive data from other nodes connected to a network 110 (e.g., an Internet Protocol (IP) network) to which network interface 1448 is connected (directly or indirectly) (e.g., network interface 1448 may be wirelessly connected to the network 110, in which case network interface 1448 is connected to an antenna arrangement); and a storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes apparatus 1400 to perform steps described herein (e.g., steps described herein with reference to the flow charts). In other embodiments, apparatus 1400 may be configured to perform steps described herein without the need for code. That is, for example, PC 1402 may consist merely of one or more ASICs. Hence, the features of the embodiments described herein may be implemented in hardware and/or software.

### SUMMARY OF EMBODIMENTS

A1. A method (1300) of encoding point data that indicates a plurality of points in a three-dimensional, 3D, environment, the method comprising:
obtaining (s1302) the point data;
grouping (s1304) the plurality of points into a plurality of slices which includes a first slice and a second slice, wherein i) the first slice includes a first set of points and a second set of points, and ii) the second slice includes the first set of points and the second set of points; and
encoding (s1306) the point data using the plurality of slices, wherein
encoding the point data using the plurality of slices comprises:
   for the first slice, encoding first point data indicating the first set of points, thereby generating a first encoding point; and
   for the second slice, encoding second point data indicating the second set of points, thereby generating a second encoding point, and
the first encoding point and the second encoding point are the same.
A2. The method of embodiment A1, wherein the first slice and the second slice partially overlap.
A3. The method of embodiment A1 or A2, the method comprising:
obtaining an initial slice length value indicating an initial length of a slice along a first axis; and
obtaining an expansion length value indicating a length of an expansion area of a slice along the first axis, wherein
a length of each of the plurality of slices along the first axis is either a sum of the initial length and the length of the expansion area or a sum of the initial length and twice of the length of the expansion area, and
an overlapped area of the first slice and the second slice is twice of the length of the expansion area.
A4. The method of any one of embodiments A1-A3, wherein
the first slice includes a first initial slice area containing the first set of points and a first expansion area containing the second set of points,
the second slice includes a second initial slice area containing the second set of points and a second expansion area containing the first set of points, and
the first encoding point and the second encoding point are on a boundary surface between the first initial slice area and the first expansion area and between the second initial slice area and the second expansion area.
A5. The method of any one of embodiments A1-A4, wherein
the first encoding point is generated for the first slice based on the first set of points and the second set of points, and
the second encoding point is generated for the second slice based on the first set of points and the second set of points.
A6. The method of embodiment A5 (when embodiment A5 depends on embodiment A4), the method comprising:
for the first slice,
   determining a first surface on which the first set of points included in the first initial slice area and the second set of points included in the first expansion area are located,
for the second slice,
   determining a second surface on which the second set of points included in the second initial slice area and the first set of points included in the second expansion area are located, wherein
the first encoding point is an intersection point that the determined first surface intersects the boundary surface,
the second encoding point is an intersection point that the determined second surface intersects the boundary surface, and
the first surface and the second surface are the same.
A7. The method of any one of embodiments A3-A6, wherein grouping the plurality of points into the plurality of slices comprises:
determining dimension values each indicating a dimension of a geometry that surrounds the plurality of points, wherein each point is defined by coordinate values each of which indicates a coordinate corresponding to a dimension of the geometry;
identifying the longest dimension from among the dimensions of the geometry;
dividing each point's coordinate value corresponding to the longest dimension by the initial slice length value; and
determining which of the plurality of slices each of the plurality points belongs to based on a result of the division of each point's coordinate value corresponding to the longest dimension by the initial slice length value.
A8. The method of embodiment of A7, wherein grouping the plurality of points into the plurality of slices comprises:
identifying the second longest dimension from among the dimensions of the geometry;
dividing each point's coordinate value corresponding to the second longest dimension by the initial slice length value; and
determining which of the plurality of slices each of the plurality points belongs to based on a result of the division of each point's coordinate value corresponding to the second longest dimension by the initial slice length value.
A9. The method of any one of embodiments A3-A8, wherein
the plurality of points includes a first point,
grouping the plurality of points into the plurality of slices comprises:
   determining that the first point is included in the first slice,
   determining whether the first point is within a first adjacent area of the first slice, where the first adjacent area of the first slice is adjacent to the second slice, and
   as a result of determining that the first point is within the first adjacent area of the first slice, including the first point in the second slice.
A10. The method of any one of embodiments A3-A8, wherein
the plurality of points includes a first point within the second slice,
the first slice and the second slice area are arranged along a first axis, and
grouping the plurality of points into the plurality of slices comprises:
determining whether (a−(b×c))≤d, where a is a coordinate of the first point along the first axis, b is the initial slice length value, c is an index of the second slice along the first axis, and d is the expansion length value; and
as a result of determining that (a−(b×c))≤d, including the first point in the first slice.
A11. The method of any one of embodiments A3-A8, wherein
the plurality of points includes a first point,
the first slice and the second slice area are arranged along a first axis, and
grouping the plurality of points into the plurality of slices comprises:
   including the first point in the first slice if the following condition is satisfied:

(b×c−d)≤a≤(b×(c+1)−d),

where a is a coordinate of the first point along the first axis, b is the initial slice length value, c is an index of the second slice along the first axis, d is the expansion length value.

A12. The method of any one of embodiments A1-A11, the method comprising:
transmitting towards a decoding entity encoded point data, wherein
the encoded point data includes first encoded point data for the first slice and second encoded point data for the second slice,
the first encoded point data for the first slice indicates the first encoding point, and
the second encoded point data for the second slice indicates neither the first encoding point nor the second encoding point.
B1. A computer program (1400) comprising instructions (1444) which when executed by processing circuitry (1402) cause the processing circuitry to perform the method of any one of embodiments A1-A12.
B2. A carrier containing the computer program of embodiment B2, wherein the carrier is one of an electronic signal, an optical signal, a radio signal, and a computer readable storage medium.
C1. An apparatus (1400) for encoding point data that indicates a plurality of points in a three-dimensional, 3D, environment, the apparatus being configured to:
obtain (s1302) the point data;
group (s1304) the plurality of points into a plurality of slices which includes a first slice and a second slice, wherein i) the first slice includes a first set of points and a second set of points, and ii) the second slice includes the first set of points and the second set of points; and
encode (s1306) the point data using the plurality of slices, wherein
encoding the point data using the plurality of slices comprises:
   for the first slice, encoding first point data indicating the first set of points, thereby generating a first encoding point; and
   for the second slice, encoding second point data indicating the second set of points, thereby generating a second encoding point, and
the first encoding point and the second encoding point are the same.
C2. The apparatus of embodiment C1, wherein the apparatus is further configured to perform the method of any one of embodiments A2-A12.
D1. An apparatus (1400) comprising:
a processing circuitry (1402); and
a memory (1441), said memory containing instructions executable by said processing circuitry, whereby the apparatus is operative to perform the method of any one of embodiments A1-A12.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCE LIST

1. Graziosi, D., Nakagami, O., Kuma, S., Zaghetto, A., Suzuki, T. and Tabatabai, A., 2020. An overview of ongoing point cloud compression standardization activities: video-based (V-PCC) and geometry-based (G-PCC). APSIPA Transactions on Signal and Information Processing, 9(1).

1. A method of encoding point data that indicates a plurality of points in a three-dimensional (3D) environment, the method comprising:
obtaining the point data;
grouping the plurality of points into a plurality of slices which includes a first slice and a second slice, wherein i) the first slice includes a first set of points and a second set of points, and ii) the second slice includes the first set of points and the second set of points; and
encoding the point data using the plurality of slices, wherein
encoding the point data using the plurality of slices comprises:
for the first slice, encoding first point data indicating the first set of points, thereby generating a first encoding point; and
for the second slice, encoding second point data indicating the second set of points, thereby generating a second encoding point, and
the first encoding point and the second encoding point are the same.

2. The method of claim 1, wherein the first slice and the second slice partially overlap.

3. The method of claim 1, the method comprising:
obtaining an initial slice length value indicating an initial length of a slice along a first axis; and
obtaining an expansion length value indicating a length of an expansion area of a slice along the first axis, wherein
a length of each of the plurality of slices along the first axis is either a sum of the initial length and the length of the expansion area or a sum of the initial length and twice of the length of the expansion area, and
an overlapped area of the first slice and the second slice is twice of the length of the expansion area.

4. The method of claim 1, wherein
the first slice includes a first initial slice area containing the first set of points and a first expansion area containing the second set of points,
the second slice includes a second initial slice area containing the second set of points and a second expansion area containing the first set of points, and
the first encoding point and the second encoding point are on a boundary surface between the first initial slice area and the first expansion area and between the second initial slice area and the second expansion area.

5. The method of claim 4, wherein
the first encoding point is generated for the first slice based on the first set of points and the second set of points, and
the second encoding point is generated for the second slice based on the first set of points and the second set of points.

6. The method of claim 5, the method comprising:
for the first slice,
determining a first surface on which the first set of points included in the first initial slice area and the second set of points included in the first expansion area are located,
for the second slice,
determining a second surface on which the second set of points included in the second initial slice area and the first set of points included in the second expansion area are located, wherein
the first encoding point is an intersection point that the determined first surface intersects the boundary surface,
the second encoding point is an intersection point that the determined second surface intersects the boundary surface, and
the first surface and the second surface are the same.

7. The method of claim 3, wherein grouping the plurality of points into the plurality of slices comprises:
determining dimension values each indicating a dimension of a geometry that surrounds the plurality of points, wherein each point is defined by coordinate values each of which indicates a coordinate corresponding to a dimension of the geometry;
identifying the longest dimension from among the dimensions of the geometry;
dividing each point's coordinate value corresponding to the longest dimension by the initial slice length value; and
determining which of the plurality of slices each of the plurality points belongs to based on a result of the division of each point's coordinate value corresponding to the longest dimension by the initial slice length value.

8. The method of claim 7, wherein grouping the plurality of points into the plurality of slices comprises:
identifying the second longest dimension from among the dimensions of the geometry;
dividing each point's coordinate value corresponding to the second longest dimension by the initial slice length value; and
determining which of the plurality of slices each of the plurality points belongs to based on a result of the division of each point's coordinate value corresponding to the second longest dimension by the initial slice length value.

9. The method of claim 3, wherein
the plurality of points includes a first point,
grouping the plurality of points into the plurality of slices comprises:
determining that the first point is included in the first slice,
determining whether the first point is within a first adjacent area of the first slice, where the first adjacent area of the first slice is adjacent to the second slice, and
as a result of determining that the first point is within the first adjacent area of the first slice, including the first point in the second slice.

10. The method of claim 3, wherein
the plurality of points includes a first point within the second slice,
the first slice and the second slice area are arranged along a first axis, and
grouping the plurality of points into the plurality of slices comprises:
determining whether (a−(b×c))≤d, where a is a coordinate of the first point along the first axis, b is the initial slice length value, c is an index of the second slice along the first axis, and d is the expansion length value; and
as a result of determining that (a−(b×c))≤d, including the first point in the first slice.

11. The method of claim 3, wherein
the plurality of points includes a first point,
the first slice and the second slice area are arranged along a first axis, and
grouping the plurality of points into the plurality of slices comprises:
including the first point in the first slice if the following condition is satisfied:
(b×c−d)≤a≤(b×(c+1)−d),
where a is a coordinate of the first point along the first axis, b is the initial slice length value, c is an index of the second slice along the first axis, d is the expansion length value.

12. The method of claim 1, the method comprising:
transmitting towards a decoding entity encoded point data, wherein
the encoded point data includes first encoded point data for the first slice and second encoded point data for the second slice,
the first encoded point data for the first slice indicates the first encoding point, and
the second encoded point data for the second slice indicates neither the first encoding point nor the second encoding point.

13. A computer program comprising instructions which when executed by processing circuitry cause the processing circuitry to perform the method of claim 1.

14. The method of claim 1, wherein
the first encoding point is generated for the first slice based on the first set of points and the second set of points, and
the second encoding point is generated for the second slice based on the first set of points and the second set of points.

15. An apparatus for encoding point data that indicates a plurality of points in a three-dimensional (3D) environment, the apparatus comprising:
a processing circuitry; and
a memory, the memory containing instructions executable by the processing circuitry, wherein the apparatus is operative to:
obtain the point data;
group the plurality of points into a plurality of slices which includes a first slice and a second slice, wherein i) the first slice includes a first set of points and a second set of points, and ii) the second slice includes the first set of points and the second set of points; and
encode the point data using the plurality of slices, wherein
encoding the point data using the plurality of slices comprises:
for the first slice, encoding first point data indicating the first set of points, thereby generating a first encoding point; and
for the second slice, encoding second point data indicating the second set of points, thereby generating a second encoding point, and
the first encoding point and the second encoding point are the same.

16. The apparatus of claim 15, wherein the first slice and the second slice partially overlap.

17. (canceled)
